(19) United States
(12) Patent Application Publication
(10) Pub. No.: US 2026/0341063 A1
(43) Pub. Date: Oct. 29, 2026

(54) system and method for validating a document based on images of the document

(71) Applicant: Bank of America Corporation, Charlotte, NC (US)

(72) Inventors: Saurabh Arora, Gurugram (IN); Sandeep Kumar Chauhan, Hyderabad (IN)

(21) Appl. No.: 19/193,160

(22) Filed: Apr. 29, 2025

(51) Int. Cl. G06V 30/18; G06V 30/413

(52) U.S. Cl. CPC G06V 30/18019; G06V 30/413

(57) ABSTRACT

In response to receiving an indication from a sensor that a document has been placed in a security apparatus, a processor causes a camera to take an image of the document, divides the image into a plurality of image patches, and inputs the image patches to a trained AI model. The AI model compares each image patch to one or more other image patches and determines that the document includes a known security anomaly based on the comparison. In response, the processor flags the document as an insecure document and stops a data interaction requested by the document from being performed.

### TECHNICAL FIELD

The present disclosure relates generally to network security, and more specifically to a system and method for validating a document based on images of the document.

### BACKGROUND

A user may request that one or more data interactions be performed in the computing infrastructure. Some conventional systems allow users to request data interactions using physical documents. However, conventional systems suffer from several limitations relating to verifying authenticity of the documents that request data interactions resulting in unauthorized data interactions being performed in the computing infrastructure.

### SUMMARY

The system and method implemented by the system as disclosed in the present disclosure provide technical solutions to the technical problems discussed above by proactively verifying authenticity of documents that request data interactions promptly and accurately.

Users may generally request that one or more data interactions be performed in the computing infrastructure. For example, a first user may request that a requested amount of data objects be transmitted from a first user profile of the first user to a second user profile of a second user. Some conventional systems allow users to request data interactions using physical documents. For example, a user may fill out a document such as a data transfer request form to request transfer of data objects between two user profiles, wherein the completed request form document may include, but is not limited to, a source user profile ID of a source user profile, a target user profile ID of a target user profile, and an amount of data objects to be transferred from the source user profile to the target user profile. Before a data interaction requested by a document is initiated, the document must be first verified to check the authenticity of the document and whether unauthorized alterations have been carried to the document to request unauthorized data interactions.

However, conventional systems suffer from several limitations associated with processing documents (e.g., verification of documents) that request data interactions. Conventional systems leverage Optical Character Recognition (OCR) technology to validate documents. For example, OCR is used to extract textual information from the documents and authenticity of the documents and requested data interactions is verified based purely on the extracted text from the documents. Once a document is deemed to be successfully verified, a respective data interaction requested by the document is initiated. However, OCR technology is not ideal to authenticate documents. For example, OCR technology used in conventional systems has several limitations when it comes to verifying authenticity of documents and detecting unauthorized/fraudulent changes made to the documents. For example, OCR operates on the visual layer. If a document is digitally altered (e.g., photoshopped), OCR may extract the modified text without flagging it. OCR does not detect pixel-level edits, such as font inconsistencies, irregular spacing, or cloned areas, which might indicate tampering. Another limitation of OCR technology is that OCR cannot verify the authenticity of digital signatures, logos, stamps, seals, watermarks or embedded metadata in documents. Another limitation is that OCR cannot detect if the layout of the document has changed (e.g., swapped text boxes or repositioned content). Another limitation is that OCR accuracy drops significantly when a document is of poor quality (e.g., handwritten text, low resolution scans, unusual fonts or backgrounds, smudges, stains or overlays etc.). Because of these limitations, verification of documents in conventional OCR-based verification systems is often unable to detect fraudulently modified documents resulting in approval and processing of unauthorized data interactions.

Unauthorized data interactions initiated based on ineffective verification of documents may result in a data breach that includes access to sensitive data, such as personal information without authorization. For example, an unauthorized data interaction may exfiltrate data by transmitting confidential data to unauthorized devices. In some cases, the stolen data may be used to perform other unauthorized data interactions within the computing infrastructure and to gain access to other computing nodes. In additional to causing security incidents, unauthorized data interactions in a computing system negatively affect performance of the computing system. For example, processing of unauthorized data interactions increase processing load on the computing nodes as processing, memory and networking resources are expended to process those data interactions and then later investigate and reverse those interactions. High volumes of unauthorized data interactions may worsen this issue and may severely compromise performance of the computing system or a portion thereof.

Embodiments of the present disclosure provide several practical applications and technical advantages that provide solutions to the problems discussed above in relation to conventional computing systems and networks. For example, the disclosed system and methods provide the practical application of verifying authenticity of documents that request data interactions accurately and promptly. As described in embodiments of the present disclosure, when a document requesting a data interaction is received at a security apparatus, a computing node associated with the security apparatus causes a camera deployed at the apparatus to capture an image of the document. The computing node then divides the image of the document into a plurality of image patches, wherein each image patch includes a portion of the document. The computing node then employs a trained AI model to determine whether the document includes any known security anomalies. For example, the AI model is configured to compare each image patch of the document with one or more other image patches of the document to determine whether any known inconsistencies are present in the document. For example, based on the comparison of the image patches of the document, the trained AI model may detect one or more known inconsistencies and, in response, output a corresponding known security anomaly. In response to the AI model detecting a known security anomaly in the document, the computing node designates the document as an insecure document and stops the data interaction requested by the document from being performed in the computing infrastructure.

Thus, unlike conventional systems where OCR technology is used to verify documents, the disclosed system and methods use an image-based verification technique to reliably verify documents and detect unauthorized alterations to the documents with high degree of accuracy. This allows the disclosed system and method to stop most or all unauthorized transactions from being processed in the computing infrastructure. The disclosed system and method provide several technical advantages. For example, by detecting inauthentic documents and by not performing unauthorized data interactions requested by these documents, the disclosed system and method avoid sensitive data from being transferred to unauthorized computing nodes, thereby avoiding the sensitive data from being stolen by bad actors. Protecting sensitive from being stolen improves data security of computing systems and network systems. In addition, the disclosed system and methods improve performance of the computing system that processes data interaction. For example, not processing unauthorized data interactions results in the computing system needing to process fewer data interactions which reduces processing load on the system. Further, there is lesser processing overhead otherwise needed to investigate and reverse unauthorized data interactions. For example, detecting an unauthorized data interaction at an early stage (e.g., before the interaction is initiated) means less frequent triggering of complex fraud detection algorithms which are typically computationally complex.

Thus, the disclosed system and method generally improve the technology associated with data security of computing networks.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a schematic diagram of a system, in accordance with certain aspects of the present disclosure;

FIG. 2 illustrates an example image of document received by security apparatus that has been divided into image patches, in accordance with one or more embodiments of the present disclosure; and

FIG. 3 illustrates a flowchart of an example method for verifying a document 112, in accordance with one or more embodiments of the present disclosure.

### DETAILED DESCRIPTION

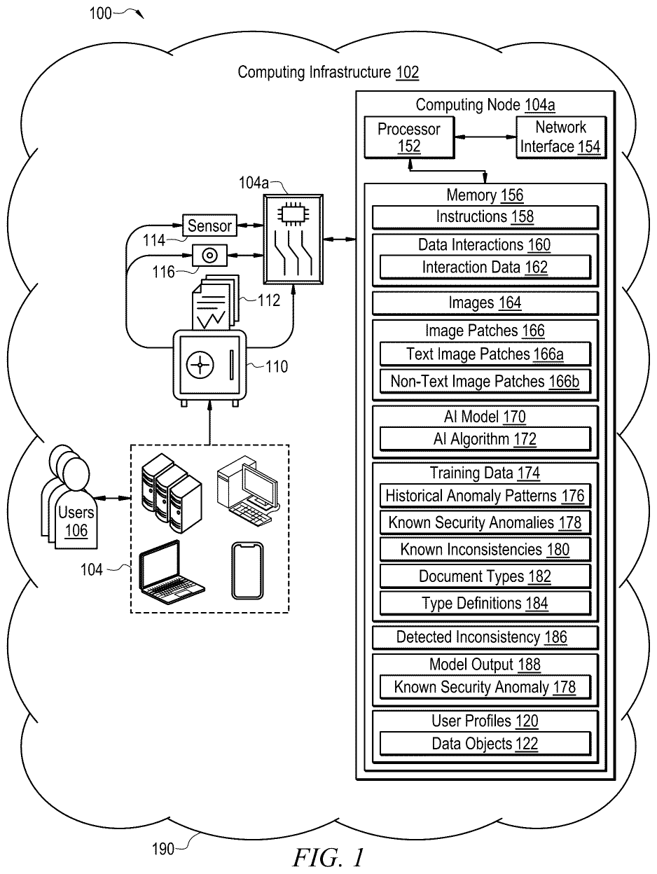

FIG. 1 is a schematic diagram of a system 100, in accordance with certain aspects of the present disclosure. As shown, system 100 includes a computing infrastructure 102 connected to a network 190. Computing infrastructure 102 may include a plurality of hardware and software components. The hardware components may include, but are not limited to, computing nodes 104 such as desktop computers, smartphones, tablet computers, laptop computers, single board computers, data servers and data centers, mainframe computers, virtual reality (VR) headsets, augmented reality (AR) glasses and other hardware devices such as printers, routers, hubs, switches, and memory all connected to the network 190. Software components may include software applications that are run by one or more of the computing nodes 104 including, but not limited to, operating systems, user interface applications, third party software, database management software, service management software, mainframe software, metaverse software, AI tools and other customized software programs implementing particular functionalities. For example, software code relating to one or more software applications may be stored in a memory device and one or more processors (e.g., belonging to one or more computing nodes 104) may execute the software code to implement respective functionalities. An example software application run by one or more computing nodes 104 of the computing infrastructure 102 may include a software program for verifying authenticity of documents 112 as described in embodiments of the present disclosure. In one embodiment, at least a portion of the computing infrastructure 102 may be representative of an Information Technology (IT) infrastructure of an organization.

One or more of the computing nodes 104 may be operated by a user 106. In this context, a computing node 104 operated by a user may be referred to as a user device. For example, a computing node 104 may provide a user interface using which a user 106 may operate the computing node 104 to perform data interactions within the computing infrastructure 102. The term “computing node 104” may be replaced by “user device” in this disclosure when the computing node 104 is operated by a user 106.

One or more computing nodes 104 of the computing infrastructure 102 may be representative of a computing system which hosts software applications that may be installed and run locally or may be used to access software applications running on a server. The computing system may include mobile computing systems including smart phones, tablet computers, laptop computers, or any other mobile computing devices or systems capable of running software applications and communicating with other devices. The computing system may also include non-mobile computing devices such as desktop computers or other non-mobile computing devices capable of running software applications and communicating with other devices. In certain embodiments, one or more of the computing nodes 104 may be representative of a server running one or more software applications to implement respective functionality as described below. In certain embodiments, one or more of the computing nodes 104 may run a thin client software application where the processing is directed by the thin client but largely performed by a central entity such as a server (not shown).

Network 190, in general, may be a wide area network (WAN), a personal area network (PAN), a cellular network, or any other technology that allows devices to communicate electronically with other devices. In one or more embodiments, network 190 may be the Internet.

Several data interactions 160 may be performed in the computing infrastructure 102. For example, a user 106 may request that one or more data interactions 160 be performed in the computing infrastructure 102. Data interactions that may be performed in the computing infrastructure 102 may include accessing data stored in a memory device (e.g., database or server) of the computing infrastructure 102, processing data by a processing server of the computing infrastructure 102, transmission of data (e.g., data objects 122) between computing nodes 104 of the computing infrastructure 102, or a combination thereof. In some cases, performing a data interaction within the computing infrastructure 102 may include accessing, processing, and or transmission of sensitive data including, but not limited to, Non-Public Information (NPI), Personal Identification Information (PII), Production Information, or any other data that is designated as sensitive data.

For example, a first user 106 may request that a requested amount of data objects 122 be transmitted from a user profile 120 of the first user 106 to another user profile 120 of a second user 106. Some conventional systems, allow users 106 to request transfer of data (e.g., data objects 122) between user profiles 120 stored in the computing infrastructure 102 based on physical documents 112. For example, a user 106 may fill out a document 112 such as a data transfer request form to request transfer of data objects between two user profiles 120, wherein the completed request form document may include, but is not limited to, a source user profile ID of a source user profile 120, a target user profile ID of a target user profile 120, an amount of data objects 122 to be transferred from the source user profile 120 to the target user profile 120, and signature of the requesting user 106. Conventional systems provide a lockbox mechanism for collection of such documents 11 from users 106, wherein lockbox is a physical device that receives documents 112 such as data transfer request forms from users 106. For example, a lockbox generally provides a mechanism that allows a user to place/insert a document 112 into the lockbox. Documents 112 received in a lockbox device are generally picked up by a service personnel in accordance with a pre-configured schedule (e.g., daily, every two days, every three days etc.). The documents 112 are then taken to a processing facility for processing where personnel physically read the documents 112 and verify the authenticity of the documents 112 and respective data interactions 160 requested by the documents 112. Some conventional systems use Optical Character Recognition (OCR) technology to extract textual information from the documents 112. The authenticity of the documents 112 and requested data interactions 160 are verified based purely on the extracted text from the documents 112. Once a document 112 is successfully verified, a respective data interaction requested by the document 112 is initiated.

However, conventional systems suffer from several limitations associated with processing documents 112 (e.g., verification of documents 112) that request data interactions. For example, OCR technology used in conventional systems has several limitations when it comes to verifying authenticity of documents 112 and detecting fraudulent changes made to the documents 112. For example, OCR operates on the visual layer. If a document is digitally altered (e.g., photoshopped), OCR may extract the modified text without flagging it. OCR does not detect pixel-level edits, such as font inconsistencies, irregular spacing, or cloned areas, which might indicate tampering. Another limitation of OCR technology is that OCR cannot verify the authenticity of digital signatures, logos, stamps, seals, watermarks or embedded metadata in documents 112. Another limitation is that OCR cannot detect if the layout of the document has changed (e.g., swapped text boxes or repositioned content). Another limitation is that OCR accuracy drops significantly when a document 112 is of poor quality (e.g., handwritten text, low resolution scans, unusual fonts or backgrounds, smudges, stains or overlays etc.). Because of these limitations, verification of documents 112 in conventional OCR-based verification systems is often unable to detect fraudulently modified documents 112 resulting in approval and processing of unauthorized data interactions 160.

Often computing systems (e.g., computing nodes 104) that store, process, or handle sensitive data in some manner are prone to cyber-attacks or data breaches in which a hacker gains unauthorized access to the computing systems and data stored on the computing systems. The term “cyber-attack” is often used interchangeably with the term “data breach” and refers to any security incident in which unauthorized parties access computing systems and sensitive or confidential information, including but not limited to, Non-Public Information (NPI), Personal Identification Information (PII), Production Information, or any other data that is designated as sensitive data. Unauthorized data interactions initiated based on ineffective verification of documents 112 may result in a data breach that includes access to sensitive data, such as personal information without authorization. For example, an unauthorized data interaction 160 may exfiltrate data by transmitting confidential data to unauthorized devices. In some cases, the stolen data may be used to perform other unauthorized data interactions within the computing infrastructure and to gain access to other computing nodes.

Another limitation of conventional systems is undesirable delays in processing of the documents 112 resulting in delayed performing of respective data interactions 160 requested by the documents 112. As noted above, documents 112 received in a lockbox device are generally picked up by a service personnel in accordance with a pre-configured schedule (e.g., daily, every two days, every three days etc.) and then processed at a processing facility. Data interactions 160 requested by the documents 112 are initiated only after successful verification of the documents 112. This process introduces undesirable delays in performing the requested data interactions.

Embodiments of the present disclosure describe an improved system and method to verify/validate documents 112 accurately and promptly.

As shown in FIG. 1, a security apparatus 110 is configured to receive documents 112 from users 106. In one embodiment, the security apparatus 110 may include a lockbox device and each document 112 received by the security apparatus 110 includes a request to perform a data interaction 160. In one example, a data interaction 160 requested by a document 112 placed/inserted into the security apparatus 110 may include transmission of a requested number of data objects 122 from a first user profile 120 to a second user profile 120. As shown in FIG. 1, the security apparatus 110 has a sensor 114 and a camera 116 disposed inside the security apparatus 110. The sensor 114 may be configured to detect reception of a new document 112 inside the security apparatus 110. In one example, the sensor 114 may be a motion sensor. However, a skilled person may appreciate that any known sensor may be used for this purpose. The camera 116 is configured to capture images 164 of documents 112 received in the security apparatus 110. While FIG. 1 illustrates a single sensor 114 and a single camera 116, a skilled person may appreciate and any number, type or combination of sensors and cameras may be used to detect reception of documents 112 in the security apparatus 110 and to capture images 164 of documents 112 in the security apparatus 110.

As shown in FIG. 1, security apparatus 110 is associated with a computing node 104a that is communicatively coupled to sensor 114 and camera 116. In one embodiment, computing node 104a is part of the computing infrastructure 102 and is connected to network 190. In one embodiment, computing node 104a may be a single board computer deployed at the security apparatus 110. A single board computer is essentially a fully functional computer typically implemented on a single printed circuit board, so it can run various types of software, including operating systems, applications, and development tools. Typical components of a single board computer may include, but are not limited to, a processor, network interface including communication ports for communication with external devices and systems, general purpose input/output (GIPO) pins that allow connectivity to control sensors motors, LEDs and other electronic components, and storage allowing storage of data, operating system and other custom software. In one example, a single board computer may be implemented using a Raspberry Pi board or Arduino board.

In an alternative embodiment, computing node 104a may be a computer locally deployed at the security apparatus 110 and communicatively coupled to the sensor 114 and camera 116 of the security apparatus 110. Local deployment of the computing node 104a at the security apparatus 110 may mean that the computing node 104a may be housed inside an outer casing/cover of the security apparatus 110 or within close proximity of the security apparatus 110 such that data travel times between the computing node 104a and the sensor 114 and camera 116 are negligible (e.g., real time or near real time). In the context of the present disclosure, computing node 104a may be a custom computer configured to implement a custom functionality described below.

In one or more embodiments, computing node 104a may be configured to verify documents 112 received in the security apparatus 110 and detect security anomalies 178. Computing node 104a may further be configured to initiate data interactions 160 upon successfully verifying respective documents 112 and stop data interactions 160 from being performed upon detecting security anomalies 178 in respective documents 112. As described below, the term “security anomaly” in the context of the present disclosure refers to fraudulent alterations made to a document 112.

The computing node 104a includes a processor 152, a memory 156, and a network interface 154. The computing node 104a may be configured as shown in FIG. 1 or in any other suitable configuration.

The processor 152 includes one or more processors operably coupled to the memory 156. The processor 152 is any electronic circuitry including, but not limited to, state machines, one or more central processing unit (CPU) chips, logic units, cores (e.g., a multi-core processor), field-programmable gate array (FPGAs), application specific integrated circuits (ASICs), or digital signal processors (DSPs). The processor 152 may be a programmable logic device, a microcontroller, a microprocessor, or any suitable combination of the preceding. The processor 152 is communicatively coupled to and in signal communication with the memory 156. The one or more processors are configured to process data and may be implemented in hardware or software. For example, the processor 152 may be 8-bit, 16-bit, 32-bit, 64-bit or of any other suitable architecture. The processor 152 may include an arithmetic logic unit (ALU) for performing arithmetic and logic operations, processor registers that supply operands to the ALU and store the results of ALU operations, and a control unit that fetches instructions from memory and executes them by directing the coordinated operations of the ALU, registers and other components.

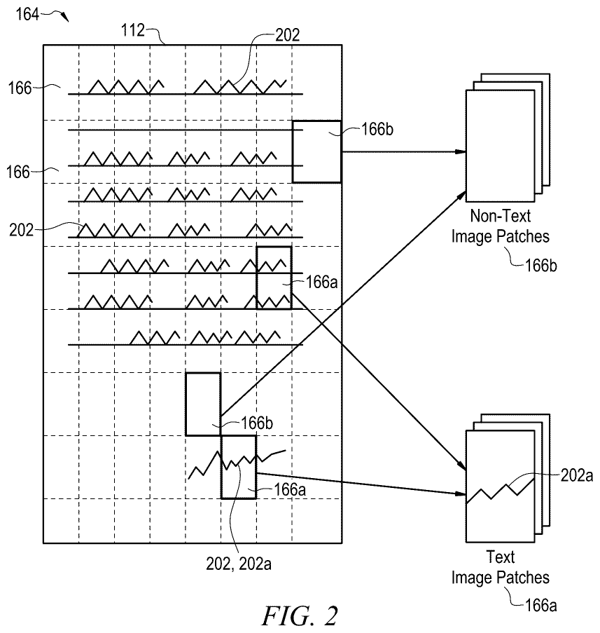

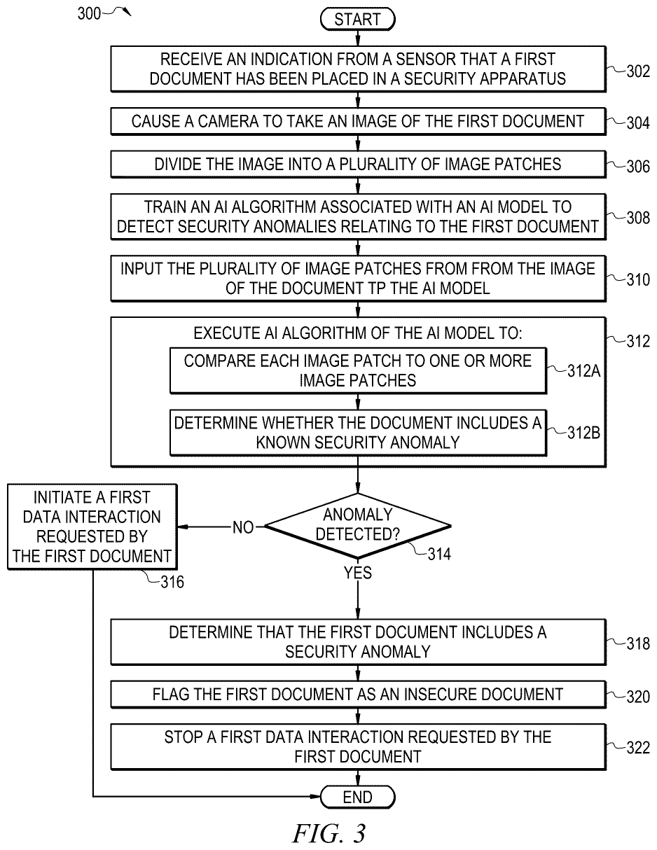

The one or more processors are configured to implement various instructions, such as software instructions. For example, the one or more processors are configured to execute instructions 158 to implement the functionality of computing node 104a. In this way, processor 152 may be a special-purpose computer designed to implement the functions disclosed herein. In one or more embodiments, the computing node 104a is implemented using logic units, FPGAs, ASICs, DSPs, or any other suitable hardware. The computing node 104a is configured to operate as described with reference to FIGS. 1 and 2. For example, the processor 152 may be configured to perform at least a portion of method 300 as described with reference to FIG. 3.

The memory 156 includes a non-transitory computer-readable medium such as one or more disks, tape drives, or solid-state drives, and may be used as an over-flow data storage device, to store programs when such programs are selected for execution, and to store instructions and data that are read during program execution. The memory 156 may be volatile or non-volatile and may include a read-only memory (ROM), random-access memory (RAM), ternary content-addressable memory (TCAM), dynamic random-access memory (DRAM), and static random-access memory (SRAM).

The memory 156 is operable to store the instructions 158, information relating to data interactions 160 including interaction data 162, images 164 of documents 112 captured by camera 116, image patches 166 including text image patches 166a and non-text image patches 166b, Artificial Intelligence (AI) model 170 (including AI algorithms 172 used by AI model 170), training data 174 (including historical anomaly patterns 176, known security anomalies 178, known inconsistencies 180, document types 182, type definitions 184 etc.), detected inconsistencies 186 in documents 112, model output 188 (including known security anomalies 178 detected in documents 112), user profiles 120 of users 106 (including data objects 122 stored in respective user profiles 120), and any other data needed to perform operations of the computing node 104a as described in embodiments of the present disclosure. The instructions 158 may include any suitable set of instructions, logic, rules, or code operable to execute the functionalities implemented by the computing node 104a.

The network interface 154 is configured to enable wired and/or wireless communications. The network interface 154 is configured to communicate data between the computing node 104a and other devices, systems, or domains (e.g., sensor 114, camera 116, other computing nodes 104). For example, the network interface 154 may include a Wi-Fi interface, a LAN interface, a WAN interface, a modem, a switch, or a router. The processor 152 is configured to send and receive data using the network interface 154. The network interface 154 may be configured to use any suitable type of communication protocol as would be appreciated by one of ordinary skill in the art.

It may be noted that each of the computing nodes 104 may be implemented like the computing node 104a shown in FIG. 1. For example, each of the computing nodes 104 may have a respective processor and a memory that stores data and instructions to perform a respective functionality of the computing node 104.

Computing node 104a may be configured to proactively verify the authenticity of documents 112 received (e.g., placed/inserted) by the security apparatus 110. As described below in more detail, verifying authenticity of a document 112 includes checking whether the document 112 has been tampered with and whether fraudulent/unauthorized alterations have been made to the document 112.

As described above, security apparatus 110 may be configured to receive documents 112 from users 106. For example, the security apparatus 110 may provide a mechanism that allows users to place/insert documents 112 inside the security apparatus 110. In one or more embodiments, a document 112 received by the security apparatus 110 may request that a particular data interaction 160 be performed and may provide information relating to the requested data interaction 160. For example, a document 112 may request a data interaction 160 including transmission of a requested number of data objects 122 from a first user profile 120 to a second user profile 120.

In operation, when a new document 112 is received by (e.g., placed/inserted) the security apparatus 110, sensor 114 may be detect the reception of the new document 112 and transmit an indication of the detection to computing node 104a. In response to receiving the indication from the sensor 114 indicating that a new document 112 has been received in the security apparatus 110, computing node 104a causes the camera 116 to take an image 164 of the newly received document 112. Thereafter, computing node 104a logically divides the image 164 of the document 112 into a plurality of image patches 166, wherein each image patch 166 includes a portion of the image 164 of the document 112.

FIG. 2 illustrates an example image 164 of document 112 received by security apparatus 110 that has been divided into image patches 166, in accordance with one or more embodiments of the present disclosure. As shown in FIG. 2, image 164 of document 112 is divided into a plurality of image patches 166 shown as a grid of image patches 166, wherein each image patch 166 includes a distinct portion of the image 164. As shown in FIG. 2, image patches 166 of the document 112 include text image patches 166a and non-text image patches 166b. Essentially, computing node 104a divides image patches 166 into a first set of text image patches 166a and second set of non-text image patches 166b. Text image patches 166a include those image patches 166 having at least a portion text 202 included in the document 112. For example, as shown in FIG. 2, a text image patch 166a includes a portion of a signature 202a included in the document 112. The text image patches 166a may include portions of the image 164/document 112 that include, but are not limited to, handwritten text, and other printed text and numbers such as document ID, user ID, user profile IDs of source and target user profiles 120, name of a user 106, address of the user 106 etc. Non-text image patches 166b include those image patches 166 that do not include any text 202. However, it may be noted that non-text image patches 166 may include portions of the image 164/document 112 that include logos, stamps, seals, and other security features including, but not limited to, watermarks, embedded metadata, holograms, microprinting, security threads, patterns, embossing, and debossing in documents 112. It may be noted that division of image 164 into image patches 166 as shown in FIG. 2 is for illustrative purposes only, and that an image 164 of the document 112 may be divided into any pre-configured number of image patches 166 of pre-configured shapes and sizes.

Once the image patches 166 including text image patches 166a and non-text image patches 166b are generated, computing node 104a may employ a trained artificial intelligence (AI) model 170 to verify the authenticity of the document 112 based on the image patches 166 of the document 112. An artificial intelligence (AI) model (e.g., AI models 170 shown in FIG. 1) is a mathematical framework that learns patterns from data in order to make predictions or decisions without being explicitly programmed for every task. The model is designed to recognize relationships or patterns within the input data (features) and use this learned information to make predictions on new, unseen data. The core idea is that the AI model “learns” from historical data (training data 174) and generalizes that learning to make accurate predictions on test data or real-world applications. Depending on the task, AI models can be classified into several categories. For example, an AI algorithm associated with a supervised AI model is trained on labeled data (e.g., inputs paired with known outputs) to learn the mapping between inputs and outputs. An AI algorithm associated with an unsupervised AI learning model is trained on unlabeled data to find hidden patterns or groupings (e.g., clustering or dimensionality reduction). A reinforcement AI model learns by interacting with an environment and receiving feedback based on actions taken.

AI models (e.g., AI model 170) rely on various AI algorithms 172 to learn from data (e.g., training data 174) and make predictions, classifications, or decisions. The choice of algorithm depends on the type of task (supervised, unsupervised, reinforcement learning), the nature of the data, and the specific problem being solved. Common AI algorithms 172 used by AI models (e.g., AI model 170) include, but are not limited to, supervised learning algorithms such as regression and classification algorithms, unsupervised learning algorithms such as clustering algorithms and dimensionality reduction algorithms, reinforcement learning algorithms, ensemble learning algorithms, and deep learning algorithms.

In order to verify the authenticity of a document 112, computing node 104a may train an AI algorithm 172 associated with the AI model 170 to detect known security anomalies 178 based on historical anomaly patterns 176 relating to respective known security anomalies 178. Each historical anomaly pattern 176 includes a previously detected known security anomaly 178 associated with a known inconsistency 180 previously detected in a document 112. Known inconsistencies 180 in a document 112 that indicate respective known security anomalies 178 include, but are not limited to, different font styles or sizes within the same document 112 (e.g., on the same line or same paragraph), misaligned text, text that appears blurry, pixelated or misaligned compared to other portions of the document 112, overlapping or unnatural spacing between letters or words, differences in ink color or shade, areas that appear darker/lighter than other portions of the document 112, inconsistent page characteristics (e.g., type of paper, page pattern) between different portions of the same document 112, scratches, erasure marks, or abrasion in specific areas, glue residue, misplaced logos, seals, or stamps, inconsistencies in layout or design elements that don't match with known template or format of the document 112, blurry or low resolution signatures/seals and ink smudging or fading. Each of these known inconsistencies 180 relating to a characteristic of a document 112 indicates that the document 112 includes a known security anomaly 178. In other words, each known inconsistency 180 relating to a document 112 indicates that the document is fraudulently altered.

In additional or alternative embodiments, training data 174 used to train AI algorithm 172 associated with AI model 170 may include document types 182 and type definitions 184 associated with a plurality of types of documents 112. Each document type 182 represents a unique type of document 112 and is associated with a type definition 184 which defines document characteristics relating to documents 112 of the particular document type 182. Document characteristics of a particular document type 182 as defined by a respective type definition 184 may include, but are not limited to, a type of paper typically used for the particular document type 182, document type ID (e.g., form number) uniquely identifying the document type 182, a layout and design of elements in documents of the document type 182 such as placement of fields, checkboxes, logos, stamps, seals, watermarks and embedded metadata in documents 112. As further described below, the document types 182 and associated type definitions 184 allow the trained AI model 170 to identify a document type 182 of a document 112 and further determine whether the document 112 is in accordance with the type definition 184 of the identified document type 182. When a document 112 of a particular document type 182 does not fully match with the respective type definition 184, it may indicate that the document 112 has been fraudulently altered.

Once the AI algorithm 172 has been trained, computing node 104a may input image patches 166 of the document 112 into the trained AI model 170 and execute the AI algorithm 172 to cause the trained AI model 170 to verify the authenticity of the document 112 based on the image patches 166 of the document 112. In one embodiment, upon execution of the AI algorithm 172, the trained AI model 170 compares each image patch 166 of the document 112 to one or more other image patches 166 of the document 112. Based on this comparison of image patches 166 relating to different portions of the document 112, AI model may detect one or more inconsistencies (shown as detected inconsistency 186 in FIG. 1) relating to one or more characteristics of the document 112. In one embodiment, AI model 170 may be configured to compare each text image patch 166a to one or more other text image patches 166a. In an additional or alternative embodiment, AI model 170 may be configured to compare each non-text image patch 166b to one or more other non-text image patches 166b. In another additional or alternative embodiment, AI model 170 may be configured to compare one or more text image patches 166a to one or more other non-text image patches 166b.

In one embodiment, based on comparing two text image patches 166a relating to the document 112, AI model 170 may detect inconsistencies such as different font styles or sizes in different portions of the document 112 (e.g., on the same line or same paragraph), misaligned text, text that appears blurry, pixelated or misaligned compared to other portions of the document 112, overlapping or unnatural spacing between letters or words, differences in ink color or shade, and the like. For example, based on comparing two text image patches 166a that are positioned next to each other or on the same line of the document 112, AI model 170 may detect that ink shade of text in the two text image patches 166a does not match. This inconsistency in ink shades may indicate that text in the document 112 has been altered. Further, based on comparing a first text image patch 166a to several other text image patches 166a, AI model 170 may detect that text in the first text image patch 166a is of a different ink shade as compared to a same ink shade of text in each of the other text image patches 166a. This allows the AI model to identify the particular text in the document 112 that is altered. Similarly, comparison of text image patches 166a may allow the AI model 170 to identify other text related inconsistencies described above.

In one embodiment, based on comparing two non-text image patches 166b relating to the document 112, AI model 170 may detect inconsistencies such as areas that appear darker/lighter than other portions of the document 112, inconsistent page characteristics (e.g., type of paper, page pattern) between different portions of the document 112, scratches, erasure marks, or abrasion in specific areas, glue residue, misplaced logos, seals, or stamps, inconsistencies in layout or design elements that don't match with known template or format of the document 112, blurry or low resolution signatures/seals and ink smudging or fading. For example, based on comparing two non-text image patches 166b, AI model 170 may detect that a security pattern of the document does not match between the two non-text image patches 166b. This inconsistency in security pattern of the document page may indicate that the document 112 has been at least partially altered. Further, based on comparing a first non-text image patch 166b to several other non-text image patches 166b, AI model 170 may detect that the security pattern included in the first non-text image patch 166b does not match with a same security pattern in each other non-text image patches 166b. This allows the AI model 170 to identify the particular portion of the document 112 that is altered. Similarly, comparison of non-text image patches 166b may allow the AI model 170 to identify other non-text inconsistencies described earlier in this paragraph.

In one embodiment, based on comparing a text image patch 166a with one or more non-text image patches 166b, AI model 170 may be configured to detect non-text related inconsistencies between the image patches 166 described above. For example, based on comparing a text image patch 166a with a non-text image patches 166b, AI model 170 may detect that the security pattern included in portions within the text image patch that are not covered by text does not match with a security pattern included in the non-text image patch 166b. This may indicate that the portion of the document 112 included in the text image patch 166a has been altered. For example, if the portion of the document 112 having a signature has been altered, then it is likely that the security pattern of the altered signature portion of the document 112 does not match with the security pattern in the remaining document 112.

Upon detecting an inconsistency (e.g., detected inconsistency 186) based on comparison of image patches 166 of the document 112, AI model 170 determines, based on the historical anomaly patterns 176, whether the detected inconsistency 186 matches a known inconsistency 180. If the detected inconsistency 186 matches with a known inconsistency 180, AI model 170 outputs the known inconsistency 180 as a known security anomaly 178 as the model output 188 of the AI model 170.

In one embodiment, in response to detecting that the AI model 170 has output a known security anomaly 178 relating to the document 112, computing node 104a flags the document 112 as an insecure document. In addition, when the document 112 requests that a data interaction 160 be performed in the computing infrastructure 102, computing node 104a stops the requested data interaction 160 from being performed based on the document 112.

In additional or alternative embodiments, AI model 170 may be configured to determine a document type 182 of the document 112 based on the image 164 and/or image patches 166 of the document and determine whether the document 112 is in accordance with the respective type definition 184 of the identified document type 182. In this context, computing node 104a may be configured to input the image 164 of the document 112 in addition the image patches 166 as described above. Based on the image 164 and/or image patches 166 of the document, AI model 170 may be configured to extract a document type ID printed on the document 112 and that uniquely identifies the document type 182 of the document 112. Once the document type 182 of the document 112 has been identified, AI model 170 accesses the type definition 184 relating to the identified document type 182 and determines whether document characteristics of the document 112 are in accordance with the type definition 184. If any one or more document characteristics of the document 112 is found to be not in accordance with the corresponding type definition 184 defined for that document characteristic, AI model 170 determines that the document 112 has been altered. For example, if the format of the document 112 is not in accordance with the format defined in the type definition 184, AI model determines that the document 112 has been altered. In response to determining that the document 112 has been altered, AI model 170 outputs, as part of model output 188, an indication that the document 112 has been altered. In response, computing node 104a flags the document 112 as an insecure document. In addition, when the document 112 requests that a data interaction 160 be performed in the computing infrastructure 102, computing node 104a stops the requested data interaction 160 from being performed based on the document 112.

In one or more embodiments, AI model 170 may be configured to run a pre-configured number of iterations of the document verification process described above to confirm a detected security anomaly 178, before outputting the security anomaly 178 as model output 188. For example, in response to identifying a known security anomaly 178 associated with the security document 112 after running a first iteration of the document verification process described above, AI model 170 runs at least a second iteration of the document verification process described above including re-analyzing the image patches 166 to determine whether the document 112 includes a known security anomaly 178. After running the second iteration of the process, when the AI model 170 determines the same known security anomaly 178 determined after running the first iteration of the process, AI model 170 outputs the known security anomaly 178 as the model output 188.

In one or more embodiments, computing node 104a may be configured to run an initial security verification process to determine whether a data interaction 160 requested to be performed by the document 112 is actually an authorized data interaction 160. For example, computing node 104a may determine whether a user 106 requesting a transfer of a requested amount of data objects 122 from a first user profile 120 of the user 106 to a second user profile 120 is actually authorized to perform the requested transfer of data objects 122 between the two user profiles 120. For example, the document 112 may include a source user profile ID of the first user profile 120 of the user 106, a target user profile ID of the second user profile 120, and an amount of data objects 122 to be transferred from the first user profile 120 to the second user profile 120. In one example, computing node 104a may use optical character recognition (OCR) to extract information (e.g. text, numbers etc.) from the image 164 of the document 112. Based on the extracted information from the image 164, computing node 104a may extract the source user profile ID, the target user profile ID and the amount of data objects 122. Once information relating to the source user profile ID, the target user profile ID and the amount of data objects 122 has been obtained, the computing node 104a accesses and examines information relating to the first user profile and the second user profile and determines whether the user 106 can be authorized to perform the requested transfer.

In this context, computing node 104a may be configured to download information relating to user profiles 120, interaction history of the user profiles 120 including recent data interactions (transfer of data objects 122) associated with the user profiles 120. In one example, the information relating to the first user profile 120 of the user 106 may indicate that the first user profile 120 is locked. In another example, the information relating to the first user profile 120 of the user 106 may indicate that the first user profile 120 does not store sufficient data objects 122 to complete the requested transfer of the requested amount of data objects. In another example, the information relating to the second user profile 120 may indicate that the second user profile 120 is locked. In response to detecting any one or more of these situations, computing node 104a may determine that the user 106 is not authorized to perform the requested data interaction 160.

In one embodiment, computing node 104a initiates the process of verifying the authenticity of the document 112 only after determining that the requested data interaction 160 can be authorized based on the initial verification process. For example, in response to determining, based on the initial verification process, that the requested data interaction 160 can be authorized, computing node 104a causes the camera to take an image 164 of the document 112 and proceeds with the document verification process described above.

FIG. 3 illustrates a flowchart of an example method 300 for verifying a document 112, in accordance with one or more embodiments of the present disclosure. Method 200 may be performed by the computing node 104a shown in FIG. 1.

At operation 302, computing node 104a receives an indication from sensor 114 that a first document 112 has been placed in the security apparatus 110.

At operation 304, in response to receiving the indication, computing node 104a causes the camera 116 to take an image 164 of the first document 112.

As described above, when a new document 112 is received by (e.g., placed/inserted) the security apparatus 110, sensor 114 may be detect the reception of the new document 112 and transmit an indication of the detection to computing node 104a. In response to receiving the indication from the sensor 114 indicating that a new document 112 has been received in the security apparatus 110, computing node 104a causes the camera 116 to take an image 164 of the newly received document 112.

At operation 306, computing node 104a divides the image of the first document 112 into a plurality of image patches 166, wherein each image patch 166 includes a portion of the image 164 of the first document 112.

As described above, computing node 104a logically divides the image 164 of the document 112 into a plurality of image patches 166, wherein each image patch 166 includes a portion of the image 164 of the document 112. As shown in FIG. 2, image 164 of document 112 is divided into a plurality of image patches 166 shown as a grid of image patches 166, wherein each image patch 166 includes a distinct portion of the image 164. As shown in FIG. 2, image patches 166 of the document 112 include text image patches 166a and non-text image patches 166b. Essentially, computing node 104a divides image patches 166 into a first set of text image patches 166a and second set of non-text image patches 166b. Text image patches 166a include those image patches 166 having at least a portion text 202 included in the document 112. For example, as shown in FIG. 2, a text image patch 166a includes a portion of a signature 202a included in the document 112. The text image patches 166a may include portions of the image 164/document 112 that include, but are not limited to, handwritten text, and other printed text and numbers such as document ID, user ID, user profile IDs of source and target user profiles 120, name of a user 106, address of the user 106 etc. Non-text image patches 166b include those image patches 166 that do not include any text 202. However, it may be noted that non-text image patches 166 may include portions of the image 164/document 112 that include logos, stamps, seals, and other security features including, but not limited to, watermarks, embedded metadata, holograms, microprinting, security threads, patterns, embossing, and debossing in documents 112. It may be noted that division of image 164 into image patches 166 as shown in FIG. 2 is for illustrative purposes only, and that an image 164 of the document 112 may be divided into any pre-configured number of image patches 166 of pre-configured shapes and sizes.

At operation 308, computing node 104a trains an AI algorithm 172 associated with an AI model 170 to detect known security anomalies 178 relating to the first document 112, wherein the AI algorithm 172 is trained using historical anomaly patterns 176 including known security anomalies 178 associated with respective known inconsistencies 180 previously detected in documents 112, wherein each known inconsistency 180 relates to an inconsistency relating to a characteristic of a respective document 112.

As described above, in order to verify the authenticity of a document 112, computing node 104a may train an AI algorithm 172 associated with the AI model 170 to detect known security anomalies 178 based on historical anomaly patterns 176 relating to respective known security anomalies 178. Each historical anomaly pattern 176 includes a previously detected known security anomaly 178 associated with a known inconsistency 180 previously detected in a document 112. Known inconsistencies 180 in a document 112 that indicate respective known security anomalies 178 include, but are not limited to, different font styles or sizes within the same document 112 (e.g., on the same line or same paragraph), misaligned text, text that appears blurry, pixelated or misaligned compared to other portions of the document 112, overlapping or unnatural spacing between letters or words, differences in ink color or shade, areas that appear darker/lighter than other portions of the document 112, inconsistent page characteristics (e.g., type of paper, page pattern) between different portions of the same document 112, scratches, erasure marks, or abrasion in specific areas, glue residue, misplaced logos, seals, or stamps, inconsistencies in layout or design elements that don't match with known template or format of the document 112, blurry or low resolution signatures/seals and ink smudging or fading. Each of these known inconsistencies 180 relating to a characteristic of a document 112 indicates that the document 112 includes a known security anomaly 178. In other words, each known inconsistency 180 relating to a document 112 indicates that the document is fraudulently altered.

At operation 310, computing node 104a inputs the plurality of image patches from the image 164 of the first document 112 to the AI model 170.

At operation 312, computing node 104a executes the AI algorithm 172 associated with the AI model 170 to perform a plurality of operations including operations 312A and 312B described below. At operation 312A executing the AI algorithm 172 causes the AI model 170 to compare each image patch 166 relating to the document to one or more other image patches 166 relating to the document. At operation 312B, executing the AI algorithm 172 causes the AI model 170 to determine, based on comparing the image patches 166, whether the first document 112 includes a known security anomaly 178.

As described above, once the AI algorithm 172 has been trained, computing node 104a may input image patches 166 of the document 112 into the trained AI model 170 and execute the AI algorithm 172 to cause the trained AI model 170 to verify the authenticity of the document 112 based on the image patches 166 of the document 112. In one embodiment, upon execution of the AI algorithm 172, the trained AI model 170 compares each image patch 166 of the document 112 to one or more other image patches 166 of the document 112. Based on this comparison of image patches 166 relating to different portions of the document 112, AI model may detect one or more inconsistencies (shown as detected inconsistency 186 in FIG. 1) relating to one or more characteristics of the document 112. In one embodiment, AI model 170 may be configured to compare each text image patch 166a to one or more other text image patches 166a. In an additional or alternative embodiment, AI model 170 may be configured to compare each non-text image patch 166b to one or more other non-text image patches 166b. In another additional or alternative embodiment, AI model 170 may be configured to compare one or more text image patches 166a to one or more other non-text image patches 166b.

Upon detecting an inconsistency (e.g., detected inconsistency 186) based on comparison of image patches 166 of the document 112, AI model 170 determines, based on the historical anomaly patterns 176, whether the detected inconsistency 186 matches a known inconsistency 180. If the detected inconsistency 186 matches with a known inconsistency 180, AI model 170 outputs the known inconsistency 180 as a known security anomaly 178 as the model output 188 of the AI model 170.

At operation 314, computing node 104a checks whether the AI model 170 has output a known security anomaly 178 relating to the first document 112. If the AI model 170 does not output a known security anomaly 178 relating to the first document 112, method 300 proceeds to operation 316 where computing node 104a initiates a first data interaction 160 requested by the first document 112.

On the other hand, when the AI model 170 outputs a known security anomaly 178 relating to the first document 112, method 300 proceeds to operation 318 where computing node 104a determines that the first document 112 has been altered.

At operation 320, computing node 104a flags the first document 112 as an insecure document.

At operation 322, computing node 104a stops the first data interaction requested by the first document from being processed/performed in the computing infrastructure 102.

As described above, in response to detecting that the AI model 170 has output a known security anomaly 178 relating to the document 112, computing node 104a flags the document 112 as an insecure document. In addition, when the document 112 requests that a data interaction 160 be performed in the computing infrastructure 102, computing node 104a stops the requested data interaction 160 from being performed based on the document 112.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

To aid the Patent Office, and any readers of any patent issued on this application in interpreting the claims appended hereto, applicants note that they do not intend any of the appended claims to invoke 35 U.S.C. § 112(f) as it exists on the date of filing hereof unless the words “means for” or “step for” are explicitly used in the particular claim.

1. A system comprising:
a sensor that detects documents received in a security apparatus;
a camera disposed in the security apparatus to capture images of the documents received in the security apparatus; and
a memory storing an artificial intelligence (AI) model; and
a processor communicatively coupled to the memory, the sensor, and the camera, wherein the processor is configured to:
receive an indication from the sensor that a first document has been placed in the security apparatus;
in response to receiving the indication, cause the camera to take an image of the first document;
divide the image of the first document into a plurality of image patches, wherein each image patch includes a portion of the image of the first document;
train an AI algorithm associated with the AI model to detect security anomalies relating to the first document, wherein the AI algorithm is trained using historical anomaly patterns including known security anomalies associated with respective known inconsistencies previously detected in the documents, wherein each known inconsistency relates to an inconsistency relating to a characteristic of respective document;
input the plurality of image patches from the image of the first document to the AI model;
execute the AI algorithm associated with the AI model to:
compare each image patch to one or more other image patches from the plurality of image patches;
determine a first inconsistency based on the comparing of the image patches, wherein the first inconsistency indicates that a first characteristic of the first document in two of the image patches does not match;
identify, based on the historical anomaly patterns, a known security anomaly relating to the first inconsistency; and
output the identified known security anomaly as an output of the AI model;
in response to the known security anomaly output by the AI model, determine that the first document includes a security anomaly;
flag the first document as an insecure document; and
stop a first data interaction requested by the first document.

2. The system of claim 1, wherein the processor is further configured to:
identify from the plurality of image patches:
a first set of text image patches that include at least a portion of text included in the first document; and
a second set of non-text image patches that do not include text.

3. The system of claim 2, wherein the processor executes the AI algorithm associated with the AI model to:
compare each text image patch with each other text image patch from the first set of text image patches; and
compare each non-text image patch with each other non-text image patch from the second set of non-text image patches.

4. The system of claim 2, wherein the processor executes the AI algorithm associated with the AI model to:
compare each text image patch from the first set of text image patches to one or more non-text image patches from the second set of non-text image patches.

5. The system of claim 1, wherein the processor is further configured to:
extract text from the image of the first document using optical character recognition (OCR);
determine, based on the text, the first data interaction requested by the first document and a user requesting the first data interaction; and
run an initial security verification to determine whether the user is authorized to perform the first data interaction;
wherein causing the camera to take the image of the first document is in response to determining that the user is authorized to perform the first data interaction.

6. The system of claim 1, wherein the processor executes the AI algorithm associated with the AI model to:
in response to identifying the known security anomaly associated with the first document, run at least a second iteration of executing the AI algorithm; and
in response to identifying the known security anomaly in the second iteration, output the identified known security anomaly as the output of the AI model.

7. The system of claim 1, wherein each image patch is of a pre-configured shape and size.

8. A method comprising:
receiving an indication from a sensor that a first document has been placed in a security apparatus;
in response to receiving the indication, causing a camera of the security apparatus to take an image of the first document;
dividing the image of the first document into a plurality of image patches, wherein each image patch includes a portion of the image of the first document;
training an AI algorithm associated with an Artificial Intelligence (AI) model to detect security anomalies relating to the first document, wherein the AI algorithm is trained using historical anomaly patterns including known security anomalies associated with respective known inconsistencies previously detected in the documents, wherein each known inconsistency relates to an inconsistency relating to a characteristic of respective document;
inputting the plurality of image patches from the image of the first document to the AI model;
executing the AI algorithm associated with the AI model to:
compare each image patch to one or more other image patches from the plurality of image patches;
determine a first inconsistency based on the comparing of the image patches, wherein the first inconsistency indicates that a first characteristic of the first document in two of the image patches does not match;
identify, based on the historical anomaly patterns, a known security anomaly relating to the first inconsistency; and
output the identified known security anomaly as an output of the AI model;
in response to the known security anomaly output by the AI model, determining that the first document includes a security anomaly;
flagging the first document as an insecure document; and
stopping a first data interaction requested by the first document.

9. The method of claim 8, further comprising:
identifying from the plurality of image patches:
a first set of text image patches that include at least a portion of text included in the first document; and
a second set of non-text image patches that do not include text.

10. The method of claim 9, executing the AI algorithm associated with the AI model to:
compare each text image patch with each other text image patch from the first set of text image patches; and
compare each non-text image patch with each other non-text image patch from the second set of non-text image patches.

11. The method of claim 9, executing the AI algorithm associated with the AI model to:
compare each text image patch from the first set of text image patches to one or more non-text image patches from the second set of non-text image patches.

12. The method of claim 8, further comprising:
extracting text from the image of the first document using optical character recognition (OCR);
determining, based on the text, the first data interaction requested by the first document and a user requesting the first data interaction; and
running an initial security verification to determine whether the user is authorized to perform the first data interaction;
wherein causing the camera to take the image of the first document is in response to determining that the user is authorized to perform the first data interaction.

13. The method of claim 8, executing the AI algorithm associated with the AI model to:
in response to identifying the known security anomaly associated with the first document, run at least a second iteration of executing the AI algorithm; and
in response to identifying the known security anomaly in the second iteration, output the identified known security anomaly as the output of the AI model.

14. The method of claim 8, wherein each image patch is of a pre-configured shape and size.

15. A non-transitory computer-readable medium storing instructions that when executed by a processor cause the processor to:
receive an indication from a sensor that a first document has been placed in a security apparatus;
in response to receiving the indication, cause a camera of the security apparatus to take an image of the first document;
divide the image of the first document into a plurality of image patches, wherein each image patch includes a portion of the image of the first document;
train an AI algorithm associated with an Artificial Intelligence (AI) model to detect security anomalies relating to the first document, wherein the AI algorithm is trained using historical anomaly patterns including known security anomalies associated with respective known inconsistencies previously detected in the documents, wherein each known inconsistency relates to an inconsistency relating to a characteristic of respective document;
input the plurality of image patches from the image of the first document to the AI model;
execute the AI algorithm associated with the AI model to:
compare each image patch to one or more other image patches from the plurality of image patches;
determine a first inconsistency based on the comparing of the image patches, wherein the first inconsistency indicates that a first characteristic of the first document in two of the image patches does not match;
identify, based on the historical anomaly patterns, a known security anomaly relating to the first inconsistency; and
output the identified known security anomaly as an output of the AI model;
in response to the known security anomaly output by the AI model, determine that the first document includes a security anomaly;
flag the first document as an insecure document; and
stop a first data interaction requested by the first document.

16. The non-transitory computer-readable medium of claim 15, wherein instructions further cause the processor to:
identify from the plurality of image patches:
a first set of text image patches that include at least a portion of text included in the first document; and
a second set of non-text image patches that do not include text.

17. The non-transitory computer-readable medium of claim 16, wherein executing the AI algorithm associated with the AI model to:
compare each text image patch with each other text image patch from the first set of text image patches; and
compare each non-text image patch with each other non-text image patch from the second set of non-text image patches.

18. The non-transitory computer-readable medium of claim 16, wherein executing the AI algorithm associated with the AI model to:
compare each text image patch from the first set of text image patches to one or more non-text image patches from the second set of non-text image patches.

19. The non-transitory computer-readable medium of claim 15, wherein the instructions further cause the processor to:
extract text from the image of the first document using optical character recognition (OCR);
determine, based on the text, the first data interaction requested by the first document and a user requesting the first data interaction; and
run an initial security verification to determine whether the user is authorized to perform the first data interaction;
wherein causing the camera to take the image of the first document is in response to determining that the user is authorized to perform the first data interaction.

20. The non-transitory computer-readable medium of claim 15, wherein executing the AI algorithm associated with the AI model to:
in response to identifying the known security anomaly associated with the first document, run at least a second iteration of executing the AI algorithm; and
in response to identifying the known security anomaly in the second iteration, output the identified known security anomaly as the output of the AI model.
